(19) United States
(12) Patent Application Publication
(10) Pub. No.: US 2018/0218138 A1
(43) Pub. Date: Aug. 2, 2018

(54) CARD READER AND CARD ISSUING DEVICE

(71) Applicant: NIDEC SANKYO CORPORATION, Suwa-gun, Nagano (JP)

(72) Inventors: Kazutoshi ISHIKAWA, Suwa-gun, Nagano (JP); Katsuhisa HIGASHI, Suwa-gun, Nagano (JP); Kazunori TAKAHASHI, Suwa-gun, Nagano (JP); Toshiro SHIOMI, Suwa-gun, Nagano (JP)

(73) Assignee: NIDEC SANKYO CORPORATION, Suwa-gun, Nagano (JP)

(21) Appl. No.: 15/578,417

(22) PCT Filed: Jun. 23, 2016
(86) PCT No.: PCT/JP2016/068616

§ 371 Date: Nov. 30, 2017

Related U.S. Application Data
(60) Provisional application No. 62/186,886, filed on Jun. 30, 2015.

(30) Foreign Application Priority Data
Sep. 28, 2015 (JP) 2015-190003
Sep. 28, 2015 (JP) 2015-190004

(51) Int. Cl. G06F 21/32; G06K 7/08

(52) U.S. Cl. CPC G06F 21/32; G06K 7/087

(57) ABSTRACT

A card reader may include a card-inserting opening at which the card is inserted; a biometric authentication sensor arranged proximate to the card-inserting opening and structured to acquire user biometric authentication data from a user; a contact structured to read the card biometric authentication data recorded on the card; a memory structured to store the user biometric authentication data acquired by the biometric authentication sensor; and a processor configured to compare the user biometric authentication data acquired by the sensor, which is stored in the storage unit, against the card biometric authentication data recorded on the card.

### CROSS REFERENCE TO RELATED APPLICATIONS

This is the U.S. national stage of application No. PCT/JP2016/068616, filed on Jun. 23, 2016. Priority under 35 U.S.C. § 119 and 35 U.S.C. § 365 is claimed from U.S. Provisional Application No. 62/186,886, filed Jun. 30, 2015; Japanese Application No. 2015-190003, filed on Sep. 28, 2015; and Japanese Application No. 2015-190004, filed on Sep. 28, 2015, the disclosures of which are incorporated herein by reference.

### FIELD OF TECHNOLOGY

At least an embodiment of the present invention relates to a card reader which implements prescribed processing on a card. At least an embodiment of the present invention also relates to a card-issuing device which issues a card.

### BACKGROUND

Conventionally known is a game system which is equipped with multiple game units such as slot machines (Patent Reference 1, for example). A game system disclosed in Patent Reference 1 is equipped with an enrollment unit for acquiring user biometric authentication data and a server which is connected to the enrollment unit via network. With this game system, user biometric authentication data which is used in the game system is acquired by the enrollment unit connected to the server as a requirement before using the game unit.

In the game system disclosed in Patent Reference 1, every game unit is provided with a biometric authentication sensor so that, when a user uses the game unit, the biometric authentication data of the user is acquired by the biometric authentication sensor in the game unit. Also, the biometric authentication data acquired by the biometric authentication sensor in the game unit is matched against the biometric authentication data enrolled in the server; only when both biometric authentication data match with each other and the requirements to use the game unit, which are enrolled in the server, satisfy the prescribed conditions, is the user allowed to access the game unit.

### PATENT REFERENCE

### [Patent Reference 1] Unexamined US Patent Application 2004-192442 Publication

In the game system disclosed in Patent Reference 1, biometric authentication data acquired by the biometric authentication sensor of the game unit is matched against the biometric authentication data enrolled in the server when a user uses the game unit. Therefore, in this game system, security measures need to be provided to the game unit, the server and the data transmission path between the game unit and the server in order to ensure the security of the biometric authentication data. In other words, a wide range of security measures are needed to ensure the security of the biometric authentication data in this game system, which in turn increases the cost of the security measures.

In the game system disclosed in Patent Reference 1, the user biometric authentication data acquired by the enrollment unit is enrolled in the server which is connected to the enrollment unit via network. Therefore, in this game system, the security measures for the enrollment unit, the server and the data transmission path between the enrollment unit and the server are needed to ensure the security of the biometric authentication data at the time of enrollment of the biometric authentication data. In other words, a wide range of security measures are needed to ensure the security of the biometric authentication data at the time of enrollment of biometric authentication data in this game system, which in turn increases the cost of the security measures.

### SUMMARY

At least an embodiment of the present invention provides a card reader which can reduce the cost needed for security measures while the security of the biometric authentication data can still be ensured in the entire system including the card reader. At least an embodiment of the present invention provides a card-issuing device which can reduce the cost needed for security measures while the security of the biometric authentication data can still be ensured at the time of enrollment of the biometric authentication data.

To achieve the above, a card reader of at least an embodiment of the present invention comprises a card-inserting opening at which a card is inserted, a biometric authentication sensor arranged around the card-inserting opening, a data-reading means for reading biometric authentication data recorded on the card, a storage unit for storing the biometric authentication data captured by the biometric authentication sensor, and a data-matching module for matching the biometric authentication data captured by the biometric authentication sensor, which is stored in the storage unit, against the biometric authentication data on the card.

The card reader of at least an embodiment of the present invention is equipped with a biometric authentication sensor and a data-reading means for reading the biometric authentication data recorded on a card; a control unit of the card reader is provided with a storage unit for storing biometric authentication data captured by the sensor and a data-matching module for matching the biometric authentication data captured by the sensor, which is now stored in the storage unit, against the biometric authentication data on the card. Therefore, in at least an embodiment of the present invention, it is possible to match the biometric authentication data captured by the sensor against the biometric authentication data on the card inside the card reader, eliminating the necessity of transmission of the biometric authentication data between a host device, in which the card reader is mounted, and the control unit.

Therefore, in at least an embodiment of the present invention, by providing security measures for the card reader, the security of the biometric authentication data can be ensured over the entire system including the card reader. Consequently, the cost needed for providing the security measures can be reduced in at least an embodiment of the present invention while the security of the biometric authentication data can still be obtained over the entire system including the card reader. Note that the host device can properly be operated based on the matching result between the biometric authentication data captured by the sensor and the biometric authentication data on a card without the transmission of the biometric authentication data between the control unit and the host device if the control unit notifies the host device of the matching result at the data-matching module.

In at least an embodiment of the present invention, the biometric authentication sensor is arranged around the card-inserting opening of the card reader; therefore, there is no need to provide a space to install a biometric authentication sensor in the host device. Also, since the biometric authentication sensor is arranged around the card-inserting opening, a user can operate the biometric authentication sensor and insert a card at the card-inserting opening in sequence. Therefore, although the biometric authentication sensor is provided to the card reader, the user's operation of inserting a card to the card reader is facilitated. Also, the operation of the biometric authentication sensor and the insertion of the card at the card-inserting opening can be done in sequence; therefore, when a card is not inserted at the card-inserting opening, biometric authentication data is not acquired by the biometric authentication sensor. Therefore, the processing load on the card reader when a card is not inserted at the card-inserting opening can be reduced.

In at least an embodiment of the present invention, the control unit notifies the host device, in which the card reader is mounted, of the matching result at the data-matching module. In this case, the host device can properly be operated based on the matching result at the data-matching module. In addition, the host device can judge, based on the matching result at the data-matching module, whether there is a need to implement additional authentication such as ID number input.

In at least an embodiment of the present invention, the card reader may be equipped with a light-emitting mechanism for illuminating the area surrounding the biometric authentication sensor and the control unit turns on the light-emitting mechanism in the illuminating mode according to the matching result at the data-matching module. In at least an embodiment of the present invention, the card reader may be equipped with a light-emitting mechanism for illuminating the area surrounding the biometric authentication sensor, that the control unit be provided with a data-acceptability-judging module for judging whether the biometric authentication data captured by the sensor is the acceptable data that can be matched against the biometric authentication data on the card and that the light-emitting mechanism illuminate in the illuminating mode according to the judging result at the data-acceptability-judging module. With this configuration, the matching result at the data-matching module and the judging result at the data-acceptability-judging module can visually and clearly be communicated to a user.

In at least an embodiment of the present invention, the card reader may be equipped with a card passage, through which a card inserted at the card-inserting opening passes, and an open-close mechanism having an opening-closing member which is movable between the closed position, with which the card passage is closed to prevent a card from being inserted inside the card reader, and the open position, with which the card passage is opened, and that the control unit control the open-close mechanism to move the opening-closing member, which is positioned in the closed position, to the open position when the biometric authentication data captured by the sensor is the acceptable data that can be matched against the biometric authentication data on the card. With this configuration, when the biometric authentication data captured by the sensor is unacceptable data which cannot be matched against the biometric authentication data on the card and when the biometric authentication data captured by the sensor and the biometric authentication data on the card cannot be matched against each other even if the card is inserted into the card reader, a card cannot be inserted inside the card reader. Therefore, a user can be kept from making a wasteful operation of inserting the card.

In at least an embodiment of the present invention, the biometric authentication sensor is a fingerprint sensor, for example, and the data-reading means is an IC contact mechanism, which reads the biometric authentication data on the card by contacting an external connection terminal of an IC chip formed on the card, or an antenna, which reads the biometric authentication data on the card by communicating with a contactless communication antenna of the IC chip embedded in the card.

Additionally, a card-issuing device of at least an embodiment of the present invention is equipped with a card supply unit for storing un-issued cards and dispensing the cards one by one, a biometric authentication sensor for acquiring biometric authentication data, and a data-recording unit for recording the biometric authentication data acquired by the biometric authentication sensor on a card sent out from the card supply unit.

The card-issuing device of at least an embodiment of the present invention is equipped with the biometric authentication sensor and the data-recording unit which records biometric authentication data captured by the biometric authentication sensor on a card dispensed from the card supply unit. Therefore, in at least an embodiment of the present invention, the biometric authentication data acquired inside the card-issuing device can be enrolled on the card inside the card-issuing device, and accordingly, there is no need to transmit the biometric authentication data between the host control device, to which the card-issuing device is connected, and the card-issuing device. Therefore, in at least an embodiment of the present invention, by providing security measures to the card-issuing device, the security of the biometric authentication data can be ensured at the time of enrollment of the biometric authentication data. Consequently, in at least an embodiment of the present invention, the cost of the security measures can be reduced while the security of the biometric authentication data is ensured at the time of enrollment of the biometric authentication data.

In at least an embodiment of the present invention, the card-issuing device may be equipped with at least either a card reader or a scanner which acquires other types of personal recognition data which is different from biometric authentication data. With this configuration, personal recognition data acquired by the card reader or the scanner can be recorded on a card, for example. When personal recognition data is recorded on a card, the biometric authentication data and the personal recognition data can be associated with each other on the card.

In at least an embodiment of the present invention, the card-issuing device may be equipped with a printer for printing on a card. With this configuration, information with low confidentiality among the information corresponding to the personal recognition data acquired by the card reader or the scanner can be printed on a card.

In at least an embodiment of the present invention, the biometric authentication sensor is a fingerprint sensor; the data-recording unit is a contact-type IC card reader having an IC contact mechanism which records biometric authentication data on the IC chip by contacting an external contact terminal of an IC chip formed on a card, or a contactless IC card reader having a communication antenna which records biometric authentication data on the IC chip by communicating with a contactless communication antenna of an IC chip embedded in a card.

As described above, the card reader of at least an embodiment of the present invention can reduce the cost for security measures while the security of the biometric authentication data can still be ensured for the entire system including the card reader.

Also, the card-issuing device of at least an embodiment of the present invention can reduce the cost for security measures while the security of the biometric authentication data can still be ensured at the time of enrollment of the biometric authentication data.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a block diagram of the entire system including a card reader of an embodiment of the present invention.

FIG. 2 is a perspective view of the card reader shown in FIG. 1.

FIG. 3 is a cross-sectional view of the front end portion of the card reader shown in FIG. 2.

FIG. 4 is a block diagram of the entire system including a card-issuing device of an embodiment of the present invention.

FIG. 5 is a perspective view of the card-issuing device shown in FIG. 4.

FIG. 6. Is a plan view of a card shown in FIG. 2 (or FIG. 5).

### DETAILED DESCRIPTION

At least an embodiment of the present invention is described hereinafter referring to the drawings.

### (Configuration of Card Reader)

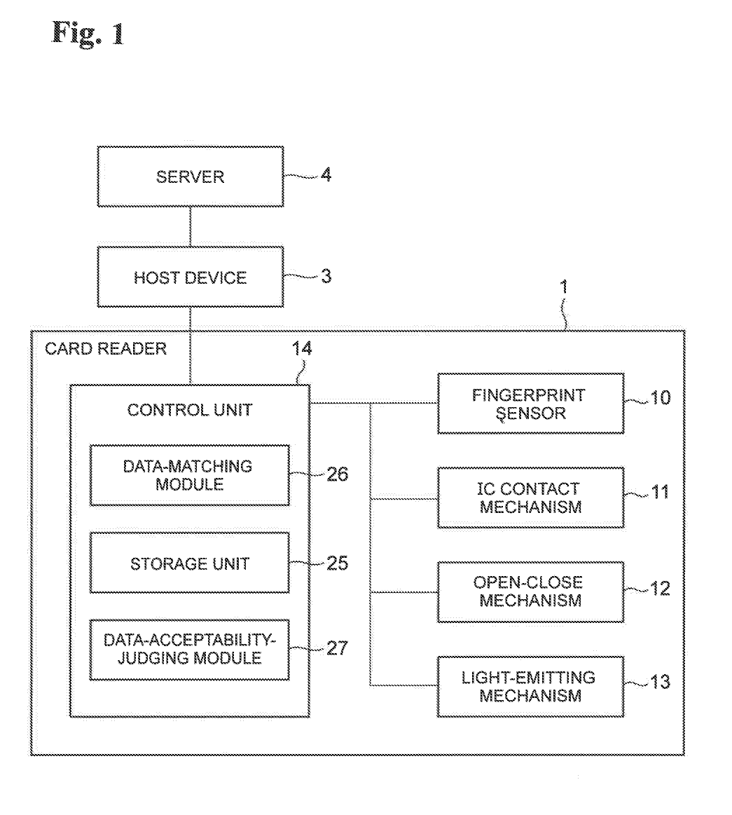

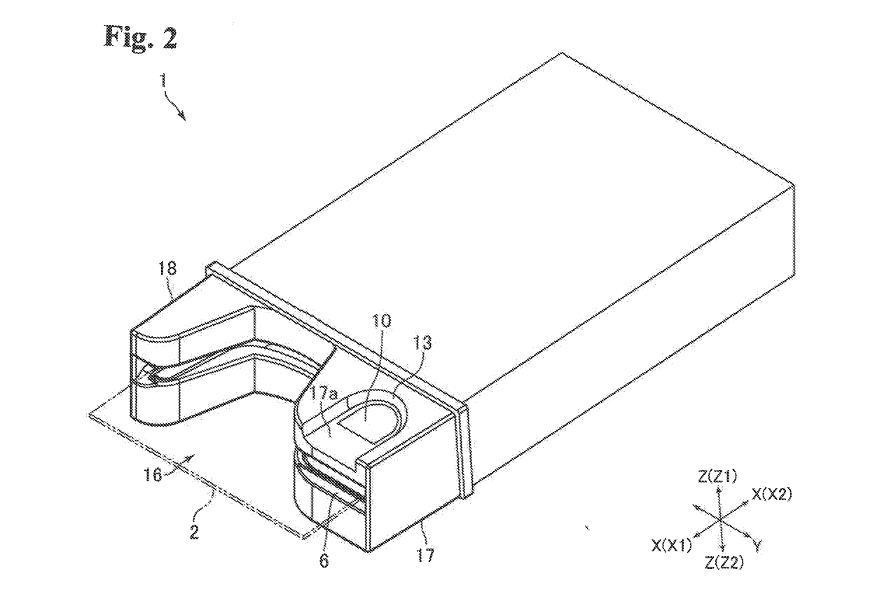

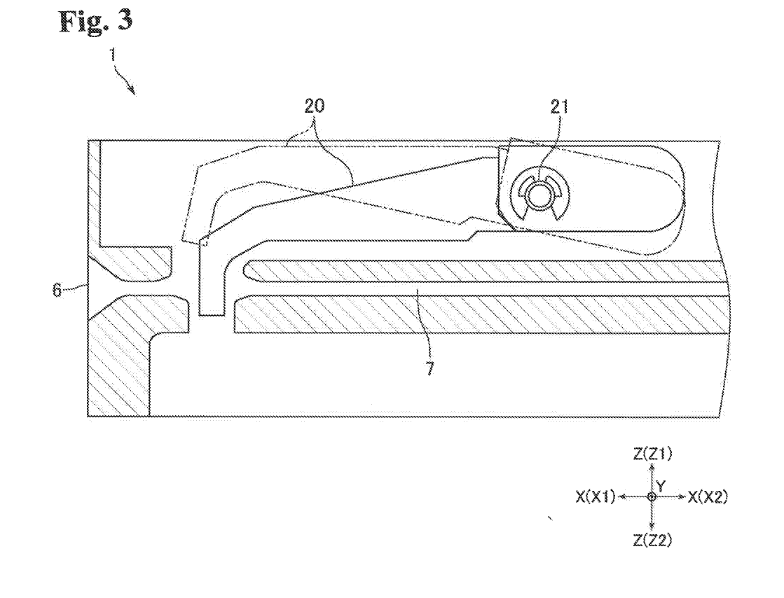

FIG. 1 is the block diagram of the entire system including a card reader 1 of an embodiment of the present invention. FIG. 2 is the perspective view of the card reader 1 of FIG. 1. FIG. 6 is the plan view of a card 2 shown in FIG. 2. FIG. 3 is a cross-sectional view of the front end portion of the card reader 1 shown in FIG. 2.

### [FIG. 25]

The card reader 1 of this embodiment is a device for reading recorded data on the card 2. More specifically described, the card reader 1 is a manual-type card reader at which a card 2 is inserted and removed by hand. The card reader 1 is mounted and used in a prescribed host device 3. The host device 3 is a game machine such as a slot machine, for example. The host device 3 is connected to a server 4 via a prescribed cable or network.

The card 2 is a rectangular vinyl chloride card having the thickness of 0.7 to 0.8 mm. An IC chip is embedded in the card 2, and an external connection terminal 2a of the IC chip is formed on the front surface of the card 2. On the card 2 of this embodiment, biometric authentication data is recorded in advance. More specifically described, the fingerprint data of the owner of the card 2 is recorded on the IC chip in the card 2.

Formed in the card reader 1 are a card-inserting opening 6 at which the card 2 is inserted and a card passage 7 through which the card 2 inserted at the card-inserting opening 6 passes. The card reader 1 is equipped with a fingerprint sensor 10 as a biometric authentication sensor which acquires biometric authentication data, an IC contact mechanism 11 which performs data communication with the IC chip on the card 2 by contacting the external contact terminal 2a on the card 2, an open-close mechanism 12 which opens and closes the card passage 7 and a light-emitting mechanism 13 for illuminating the area surrounding the fingerprint sensor 10. The card reader 1 is also provided with a control unit 14 which controls the card reader 1. The fingerprint sensor 10, the IC contact mechanism 11, the open-close mechanism 12 and the light-emitting mechanism 13 are connected to the control unit 14.

In the card passage 7, the card 2 moves in the X direction in FIG. 2. The Z direction in FIG. 2 which is perpendicular to the X direction is the thickness direction of the card 2 passing through the card passage 7; the Y direction in FIG. 2 which is perpendicular to the X direction and the Z direction is the width direction of the card 2 passing through the card passage 7. In the description below, the X direction is the “front-back direction”, the Y direction is the “left-right direction”, and the Z direction is the “top-bottom direction”. Also, the X1 direction side is the “front” side, the X2 direction side is the “far (back)” side, the Z1 direction side is the “top” side and the Z2 direction side is the “bottom” side.

The card-inserting opening 6 is formed at the front end of the card reader 1. As shown in FIG. 2, part of the card reader at the front end is formed as a notch portion 16 so that a user can insert and remove the card 2 easily. More specifically described, the notch portion 16 which is in a U shape when viewed from the top-bottom direction is formed such that the portion of the card reader 1 is notched from the front end toward the back. Also, the notch portion 16 is formed in the middle position in the left-right direction; a protruding portion 17 and a protruding portion 18 are formed at both ends of the notch portion 16 in the left-right direction. Formed on the top surface of the protruding portion 17 is a recess portion 17a which recesses downwardly. The recess portion 17a is formed from the front end of the protruding portion 17 toward the back. The recess portion 17a is formed to be in a U shape when viewed from the top-bottom direction.

The fingerprint sensor 10 is a sensor for acquiring the fingerprint data of a user. The fingerprint sensor 10 is arranged around the card-inserting opening 6. More specifically described, the fingerprint sensor 10 is arranged at the bottom surface of the recess portion 17a of the protruding portion 17. The light-emitting mechanism 13 is equipped with a light-emitting device such as an LED. The light-emitting mechanism 13 is arranged to surround the back end portion of the fingerprint sensor 10. More specifically described, the light-emitting device 13 is arranged along the side surface on the back side of the recess portion 17a.

The IC contact mechanism 11 is equipped with an IC contact block having multiple IC contact springs which contact the external contact terminal 2a on the card 2. The IC contact block is arranged on the far side of the card reader 1. The IC contact block is held by a parallel link mechanism and energized toward the front side by an energizing force of a spring member. The IC contact block is made movable between the stand-by position at which the IC contact spring detaches from the card 2 positioned in the card passage 7 and the contact position at which the external contact terminal 2a of the card 2 positioned in the card passage 7 and the IC contact spring contact with each other; when the card 2 is inserted toward the back of the card passage 7, it moves from the stand-by position to the contact position. The IC contact mechanism 11 is also a data-reading means for reading fingerprint data recorded on the card 2.

The open-close mechanism 12 is equipped with a lever member 20 as an opening-closing member (see FIG. 3). The lever member 20 is rotatably supported by a fixed shaft 21. The fixed shaft 21 is fixed to the frame of the card reader 1 such that the shaft direction thereof coincides with the left-right direction. The lever member 20 is rotatable between the closed position (indicated by solid lines in FIG. 3), with which the front portion of the card passage 7 is closed so that the card 2 cannot be inserted inside the card reader 1, and the open position (indicated by the alternate long and two short dashes line in FIG. 3) with which the front portion of the card passage 7 is opened so that the card 2 can be inserted inside the card reader 1.

The open-close mechanism 12 is equipped with a spring member which energizes the lever member 20 toward the open position and a drive source such as a solenoid which rotates the lever member 20 from the closed position to the open position. Note that the lever member 20 positioned in the closed position functions to prevent the removal of the card 2 which is inserted inside the card reader 1 for data transmission with the IC contact mechanism 11.

The control unit 14 is equipped with a storage unit 25 which stores fingerprint data (biometric authentication data) acquired by the fingerprint sensor 10, a data-matching module 26 which matches the fingerprint data recorded on the card 2 (the biometric authentication data on the card) against the fingerprint data acquired by the sensor and stored in the storage unit 25, and a data-acceptability-judging module 27 for judging whether the fingerprint data acquired by the fingerprint sensor 10 is the acceptable data which can be matched against the fingerprint data on the card. The data-matching module 26 and the data-acceptability-judging module may be implemented by a processor within the control unit 14. The control unit 14 is connected to the host device 3 via an interface, through which receives various commands from the host device 3 and notifies the host device 3 of the results of various processing implemented based on the received commands.

### (Operation of Card Reader)

In the card reader 1, in the stand-by state in which the card 2 is not inserted at the card-inserting opening 6, the lever member 20 is in the closed position keeping the front end of the card passage 7 closed. When a user places his/her finger on the fingerprint sensor 10 under this condition, fingerprint data can be acquired by the fingerprint sensor 10. The fingerprint data acquired by the sensor is transmitted to the control unit 14. Once the fingerprint data acquired by the sensor is transmitted to the control unit 14, the data-acceptability-judging module 27 judges whether the fingerprint data acquired by the fingerprint sensor 10 is the acceptable data for matching against the fingerprint data on the card which will be read by the IC contact mechanism 11 later.

When the fingerprint data acquired by the sensor is the acceptable data, the control unit 14 stores the fingerprint data acquired by the sensor in the storage unit 25. Also, when the fingerprint data acquired by the sensor is the acceptable data, the control unit 14 controls the open-close mechanism 12 (more specifically described, controls a drive source of the open-close mechanism 12) to rotate the lever member 20 positioned in the closed position to the open position. Once the lever member 20 is rotated to the open position, the card 2 can be inserted inside the card reader 1, and therefore, a user inserts the card 2 to the inside of the card reader 1 from the card-inserting opening 6. Note that, if the fingerprint data acquired by the sensor is the unacceptable data, the lever member 20 is kept in the closing state.

When the card 2 is inserted all the way to the far back of the card reader 1, the control unit 14 controls the open-close mechanism 12 to rotate the lever member 20, positioned in the open position, to the closed position to prevent the removal of the card 2. Also, when the lever member 20 is rotated to the closed position, the control unit 14 notifies the host device 3 of the condition; the host device 3 which has received the notification transmits to the control device 14 the command to prompt the communication between the card 2 and the IC contact mechanism 11. In the state in which the card 2 is inserted all the way to the far back of the card reader 1, the IC contact spring of the IC contact mechanism is in contact with the external connection terminal 2a on the card 2; once the control unit 14 receives the command to prompt the communication between the card 2 and the IC contact mechanism 11, a data transmission is implemented between the card 2 and the IC contact mechanism 11. When the data transmission between the card 2 and the IC contact mechanism 11 ends, the control unit 14 notifies the host device 3 of the transmission result.

In the data transmission between the card 2 and the IC contact mechanism 11, the fingerprint data recorded on the card 2 is read. The read fingerprint data is transmitted to the control unit 14. Once the fingerprint data on the card is transmitted to the control unit 14, the data-matching module 26 matches the fingerprint data acquired by the sensor and stored in the storage unit 25, against the fingerprint data on the card. The control unit 14 also notifies the host device 3 of the matching result from the data-matching module 26.

When the result of the data transmission between the card 2 and the IC contact mechanism 11 is acceptable and the matching result from the data-matching module 26 shows that the fingerprint data on the card agrees with the fingerprint data acquired by the sensor, the user is allowed to use the host device 3. On the other hand, when the result of the data transmission between the card 2 ad the IC contact mechanism 11 is not acceptable or the matching result at the data-matching module 26 does not indicate that the fingerprint data on the card agrees with the fingerprint data acquired by the sensor, the user is denied his/her access to the host device 3. Note that, when the fingerprint data on the card and the fingerprint data acquired by the sensor do not agree with each other in the matching result at the data-matching module 26, the host device 3 may implement additional authentication such as a PIN number input.

In this embodiment, when the fingerprint data captured by the fingerprint sensor 10 is judged as the acceptable data by the data-acceptability-judging module 27, the control unit 14 turns on the light-emitting mechanism 13 in a green color; when the fingerprint data captured by the fingerprint sensor 10 is judged as the unacceptable data by the data-acceptability-judging module 27, the control unit 14 turns on the light-emitting mechanism 13 in a red color. In other words, the control unit 14 turns on the light-emitting mechanism 13 in the color according to the judgment result at the data-acceptability-judging module 27.

When the matching result at the data-matching module 26 shows that the fingerprint data on the card and the fingerprint data captured by the fingerprint sensor 10 agree with each other, the control unit 14 turns on the light-emitting mechanism 13 in green; when the matching result at the data-matching module 26 shows that the fingerprint data on the card does not agree with the fingerprint data captured by the fingerprint sensor 10, the control unit 14 turns on the light-emitting mechanism 13 in red. In other words, the control unit 14 turns on the light-emitting mechanism 13 in the light-emitting mode according to the matching result at the data-matching module 26.

### (Major Effects of the Embodiment)

As described above, in this embodiment, the fingerprint data captured by the fingerprint sensor 10, which is a constituent of the card reader 1, is stored in the storage unit 25 in the control unit 14, which is also a constituent of the card reader 1. In this embodiment, also, the fingerprint data on the card, read by the IC contact mechanism 11 which is a constituent of the card reader 1, is matched against the fingerprint data captured by the sensor, which is stored in the storage unit 25, at the data-matching module 26 which is a constituent of the card reader 1. Further, in this embodiment, the matching result at the data-matching module 26 is notified to the host device 3 by the control unit 14; however, the fingerprint data on the card and the fingerprint data captured by the sensor is not transmitted from the control unit 14 to the host device 3.

Thus, in this embodiment, the security of the fingerprint data can be ensured in the entire system including the card reader 1 by providing the card reader 1 with a security measure. Therefore, in this embodiment, while the security of the fingerprint data is ensured in the entire system including the card reader 1, the cost needed to provide the security measure can still be reduced. Also, in this embodiment, the matching result at the data-matching module 26 is notified to the host device 3 by the control unit 14; therefore, the host device 3 can implement proper operations based on the matching result at the data-matching module 26 and can judge, based on the matching result at the data-matching module 26, whether additional authentication such as an ID number input is needed.

In this embodiment, the fingerprint sensor 10 is arranged around the card-inserting opening 6. Therefore, there is no need to save installation space for the fingerprint sensor 10 in the host device 3. Also, since the fingerprint sensor 10 is arranged around the card-inserting opening 6, a user can press his/her finger onto the fingerprint sensor 10 and insert the card 2 at the card-inserting opening 6 in sequence. Therefore, even though the fingerprint sensor 10 is arranged to the card reader 1, the operation of inserting the card 2 is facilitated for the user. In this embodiment, also, the operation of pressing a finger onto the fingerprint sensor 10 and the operation of inserting the card 2 at the card-inserting opening 6 can be done in sequence; therefore, when the card 2 is not at the card-inserting opening 6, the fingerprint data will not be taken by the fingerprint sensor 10. Therefore, in this embodiment, the processing load of the card reader 1 can be reduced when the card 2 Is not inserted at the card-inserting opening 6.

In this embodiment, the control unit 14 turns on the light-emitting mechanism 13 in the light-emitting mode according to the judgment result at the data-acceptability-judging module 27. In this embodiment, the control unit 14 also turns on the light-emitting mechanism 13 in the light-emitting mode according to the matching result at the data-matching module 26. For this reason, in this embodiment, the judging result at the data-acceptability-judging module 27 and the matching result at the data-matching module 26 can visually and clearly be transmitted to the user.

In this embodiment, when the fingerprint data which is judged by the data-acceptability-judging module 27 is the acceptable data which can be matched against the fingerprint data on the card, the control unit 14 rotates the lever member, which is in the closed position, to the open position to allow the insertion of the card 2 inside the card reader 1. Therefore, in this embodiment, if the fingerprint data taken by the sensor is the unacceptable data, which cannot be matched against the fingerprint data on the card and therefore, even when the card 2 is inserted inside the card reader 1, the fingerprint data taken by the sensor and the fingerprint data on the card cannot be matched against each other, the card 2 is not allowed to be inserted inside the card reader 1. Therefore, in this embodiment, a user is kept from a wasteful insertion of the card 2.

### Other Embodiments

The above-described embodiment is an example of embodiments of the present invention; however, it is not limited to this example, but can be varyingly modified within the scope of the present invention.

In the above-described embodiment, the external connection terminal 2a is formed on the front surface of the card 2; however, a communication antenna may be embedded in the card 2 to communicate with the IC chip embedded in the card 2 in a contactless manner. In this case, the card reader 1 is equipped with an antenna to communicate with the antenna embedded in a card as a data-reading means which reads the fingerprint data recorded on the IC chip in the card 2.

In the above-described embodiment, the fingerprint data is recorded on the IC chip in the card 2; however, the fingerprint data may be recorded in a magnetic strip formed on a card 2. In this case, the card reader 1 is equipped with a magnetic head as a data-reading means to read the fingerprint data recorded in the magnetic strip on the card 2. Also, fingerprint data may be recorded in a barcode printed on the surface of the card 2. In this case, the card reader 1 is equipped with a scanner as the data-reading means to read the fingerprint data recorded in the barcode on the card 2.

In the above-described embodiment, the biometric authentication sensor arranged around the card-inserting opening 6 is the fingerprint sensor 10 which captures the fingerprint of a user. Besides this, the biometric authentication sensor arranged around the card-inserting opening 6 may be a vein recognition sensor which acquires data of the palm or the finger vein form of a user or may be a facial recognition sensor which acquires data of the facial form of a user. The biometric authentication sensor arranged around the card-inserting opening 6 may also be an iris recognition sensor which acquires the data of an iris in the eye of a user, a retinal scan sensor which acquires the data of the retina of a user, or a voiceprint authentication sensor which acquires the data of the voiceprint of a user.

In the above-described embodiment, the lever member 20 positioned in the closed position is rotated to the open position when the fingerprint data captured by the sensor is judged at the data-acceptability-judging module 27 as the acceptable data which can be matched against the fingerprint data on the card. Besides this, a detecting mechanism for detecting that the card 2 is inserted at the card-inserting opening 6 may be installed, and therefore, when the detecting mechanism detects that the card 2 is inserted at the card-inserting opening 6, the lever member 20 in the closed position may be rotated to the open position.

In the above-described embodiment, the card reader 1 is a manual card reader; however, a card reader to which at least an embodiment of the present invention is applied may be a card-transfer type card reader having a card-transferring mechanism. Also, in the above-described embodiment, the card 2 is a vinyl chloride card having the thickness of 0.7-0.8 mm; however, the card 2 may be a PET (polyethylene terephthalate) card having the thickness of 0.7 to 0.8 mm or a paper card having the predetermined thickness. In the above-described embodiment, the host device 3 is a game device such as a slot machine; however, the host device 3 may be an ATM (Automated Teller Machine).

Also, the fingerprint sensor 10 may be equipped with a function to encrypt the fingerprint data acquired by the fingerprint sensor 10, the IC contact mechanism 11 may be equipped with a function to encrypt the fingerprint data on a card, which is read by the IC contact mechanism 11, and the control unit 14 may be equipped with a function to decode the encrypted fingerprint data acquired by the sensor and the encrypted fingerprint data on the card. In this case, the security of the card reader 1 can be increased.

The card reader 1 in the above-described embodiment may be equipped with a means to detect or prevent that the card reader 1 is illegally removed from the host device 3, that the control board (no illustration) of the card reader 1 is illegally removed from the frame of the card reader 1, or that part of the card reader 1 is broken. Even in this case, the security of the card reader 1 can be increased.

### Embodiment of the Invention

Another embodiment of the present invention is described hereinafter referring to the drawings.

### (Configuration of Card-Issuing Device)

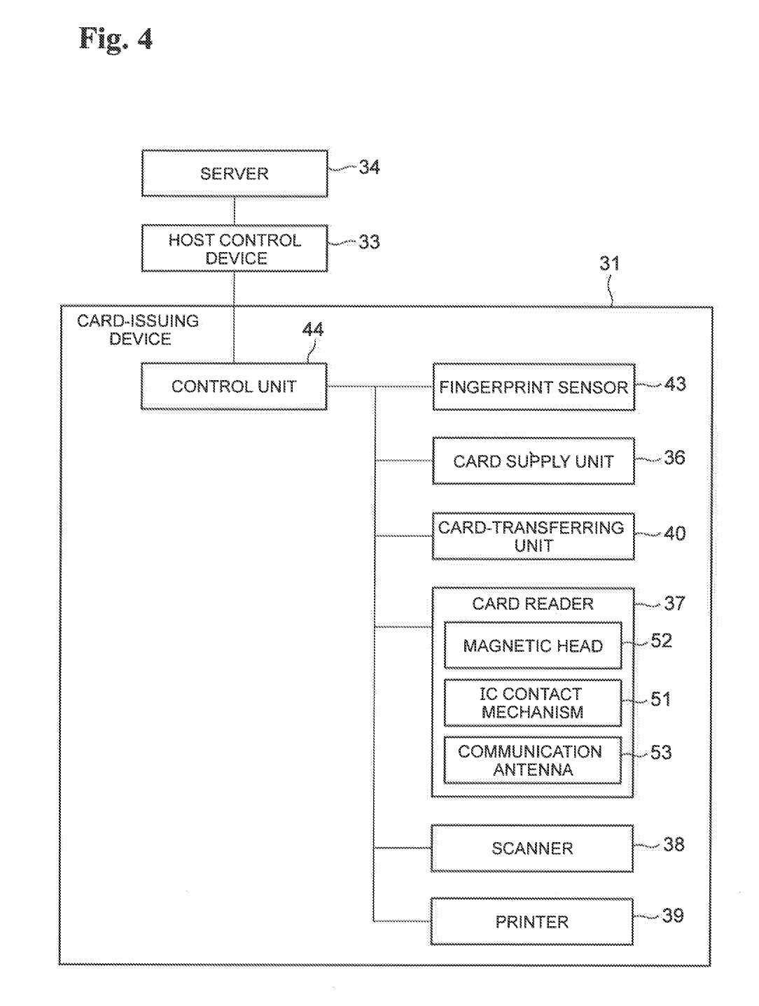

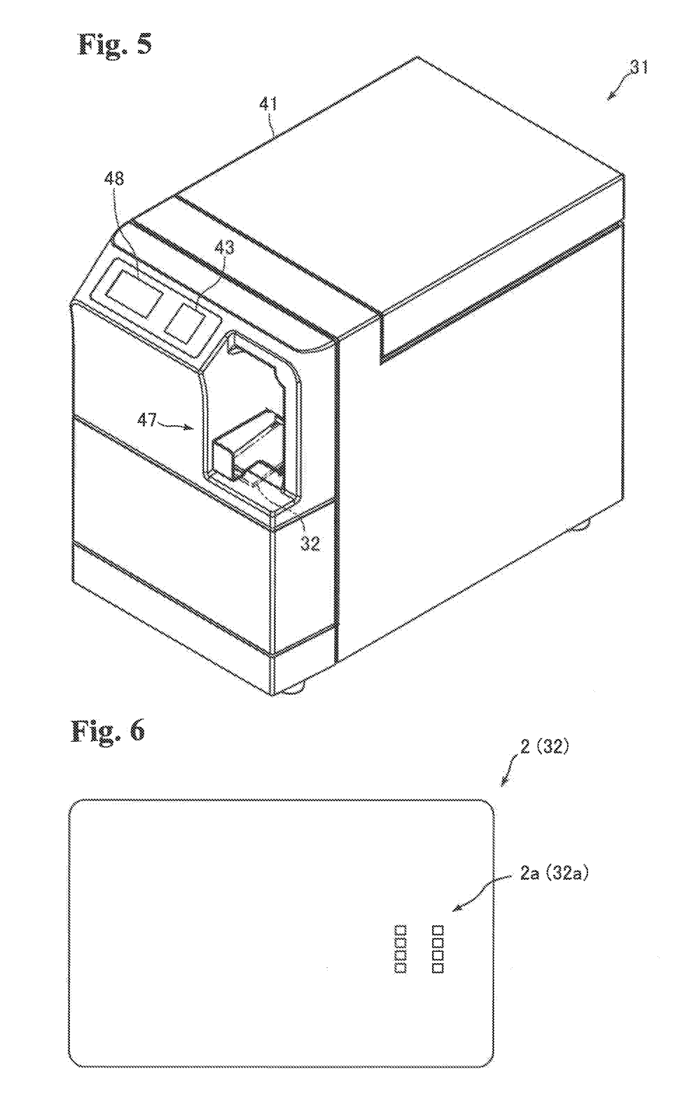

FIG. 4 is a block diagram of the entire system including a card-issuing device 31 of an embodiment of the present invention. FIG. 5 is a perspective view of the card-issuing device 31 shown in FIG. 4. FIG. 6 is a plan view of a card 2 shown in FIG. 5.

The card-issuing device 31 of this embodiment is for issuing a card 32, and mounted and used in a casino where multiple game machines such as slot machines are arranged. The card-issuing device 31 is connected to a host control device 33 such as a personal computer. The host control device 33 is connected to a server 34 via a predetermined cable or network. The card 32 is a rectangular vinyl chloride card having the thickness of 0.7 to 0.8 mm. In the card 32, an IC chip is embedded; as shown in FIG. 6, an external connection terminal 32a of the IC chip is formed on the front surface of the card 32.

The card-issuing device 31 is equipped with a card supply unit 36 which stores un-issued cards 32 and dispenses the stored cards 32 one by one, a card reader 37 which reads data recorded on the cards 32 and records data on the cards 32, a scanner 38 for acquiring image data and a printer 39 for printing on the cards 32. The card-issuing device 31 is also equipped with a card-transferring unit 40 which transfers the cards 32 between the card supply unit 36, the card reader 37, the scanner 38 and the printer 39.

The card supply unit 36, the card reader 37, the scanner 38, the printer 39 and the card-transferring unit 40 are arranged inside a case 41. The card-issuing device 31 is equipped with a fingerprint sensor 43 which is a biometric authentication sensor for acquiring biometric authentication data and a control unit 44. The card supply unit 36, the card reader 37, the scanner 38, the printer 39, the card-transferring unit 40 and the fingerprint sensor 43 are connected to the control unit 44. Also, the control unit 44 is connected to the host control device 33 via an interface.

The card supply unit 36 is equipped with a card-storing module in which multiple cards 32 prior to issuing are stacked and a card-sending mechanism which sends out the cards 32 one by one. On the card 32 stored in the card-storing module, the card individual identification data is recorded in advance in an IC chip embedded in the card 32 and the card individual identification data is printed on the front surface of the card 32 in advance. The card-transferring unit 40 is equipped with a card-holding module for temporarily holding the card 32 inside, a horizontally-moving mechanism for horizontally moving the card-holding module and a rotating mechanism for rotating the card-holding module. Note that multiple card supply units 36 are arranged inside the case in this embodiment.

The fingerprint sensor 43 is a sensor which captures fingerprint data of a user. In other words, the fingerprint sensor 43 is a sensor which captures fingerprint data as biometric authentication data. The fingerprint sensor 43 is mounted on the front face of the case 41. Also, a card-issuing opening 47 is attached on the front face of the case 41 so that the issued card 32 is discharged. Further, a display module 48 such as an LCD is attached on the front face of the case 41. The display module 48 is arranged to be next to the fingerprint sensor 43.

The card reader 37 is equipped with an IC contact mechanism 51 which performs data communication with the IC chip embedded in the card 32 by contacting with the external connection terminal 32a of the card 32. Also, the card reader 37 is a contact-type IC card reader. The card reader 37 is equipped with a magnetic head 52 which performs at least either magnetic data reading or recording and a communication antenna for performing data communication with a contactless IC card. Also, the card reader 37 is equipped with a card-transferring mechanism which transfers the card 2 inside the card reader 37.

The card reader 37 records the fingerprint data acquired by the fingerprint sensor on the card 32 which is sent from the card supply unit 36. More specifically described, the card reader 37 records the fingerprint data acquired by the fingerprint sensor 43 on the IC chip of the card 32, which is sent from the card supply unit 36, transferred by the card-transferring unit 40 to the card reader 37 and taken into the card reader 37. More specifically described, the IC contact mechanism 51 contacts the external connection terminal 32a of the card 32 to record the fingerprint data on the IC chip of the card 32. The card reader 37 of this embodiment is a data recording unit.

### (Operation of Card-Issuing Device)

When a card 32 is issued by the card-issuing device 31, a user, prompted by the instruction displayed on the display module 48, presses his/her finger onto the fingerprint sensor 43. As the user presses his/her finger onto the fingerprint sensor 43, the fingerprint data of the user is acquired by the fingerprint sensor 43. The acquired fingerprint data is transmitted to the control unit 44. Once the fingerprint data is transmitted to the control unit 44, the control unit 44 judges whether the fingerprint data acquired by the fingerprint sensor 43 is the acceptable data as the biometric authentication data. When the fingerprint data is acceptable, the control unit 44 stores it.

Then, by following the instruction on the display module 48, the user inserts an ID card on which personal recognition data other than the fingerprint data is recorded, or a passport, driver's license or identification (hereinafter referred as “passport or the like”) in which personal recognition data other than the fingerprint data is recorded, at an insertion opening (no illustration) formed in the front face of the case 41. For example, when an ID card is inserted at the insertion opening, the card-transferring unit 40 transfers the ID card to the card reader 37. The card reader 37 takes the ID card inside and reads the personal recognition data recorded on the ID card with the IC contact mechanism 51, the magnetic head 52, or the communication antenna.

Alternatively, the card-transferring unit 40 transfers the ID card inserted at the insertion opening to the scanner 38, the scanner takes the ID card in, and reads and acquires the personal recognition data recorded on the ID card. Likewise, when a passport or the like is inserted at the insertion opening, the card-transferring unit 40 transfers the passport or the like to the scanner 38, the scanner 38 takes the passport or the like in, and reads and acquires the personal recognition data recorded on the passport or the like. Also, the card reader 37 or the scanner 38 transmits the acquired personal recognition data to the control unit 44.

The card supply unit 36 sends out a single card 32, and the card-transferring unit 40 transfers the card 32, which is sent out from the card supply unit 36, to the card reader 37. The card reader 37 takes the card 32, which is transferred by the card-transferring unit 40, to the inside and reads and acquires the card individual identification data, which is recorded on the IC chip in the card 32 in advance, with the IC contact mechanism 51, and then transmits the acquired card individual identification data to the control unit 44.

Then, the control unit 44 transmits the personal recognition data, which is transmitted from the card reader 37 or the scanner 38, to the card reader 37, and the card reader 37 records the personal recognition data on the IC chip embedded in the card 32 with the IC contact mechanism 51. Also, the control unit 44 transmits the fingerprint data, which is stored therein, and the card reader 37 records the fingerprint data on the IC chip in the card 32 through the IC contact mechanism 51. Note that, when the personal recognition data is acquired by the card reader 37, the personal recognition data does not need to be transmitted between the card reader 37 and the control unit 44.

Then, the control unit 44 notifies the host control device 33 of the card individual identification data and also notifies the host control device 33 of that the personal recognition data and the fingerprint data are enrolled (recorded) on the card. Also, inside the card-issuing device 31, other necessary processing is implemented on the card 32. For example, the information requiring low confidentiality (a user name, for example) among the information corresponding to the personal recognition data acquired by the card reader 37 or the scanner 38 is printed on the card 32 by the printer 39. Once other necessary processing is implemented on the card 32, the card 32 is issued from the card-issuing opening 47. Note that the card individual identification data notified to the host control device 33 is transmitted to the server 34 from the host control device 33 and enrolled.

(Major Effect of this Embodiment)

As described above, in this embodiment, the fingerprint data acquired by the fingerprint sensor 43, which is a constituent of the card-issuing device 31, is first stored in the control unit 44 of the card-issuing device 31, transmitted to the card reader 34 which is also a constituent of the card-issuing device 31, and recorded on the IC chip in the card 32 by the card reader 37. In other words, in this embodiment, the fingerprint data acquired in the card-issuing device 31 is enrolled on the card 32 inside the card-issuing device 31. Also, in this embodiment, while the control unit 44 notifies the host control device 33 that the fingerprint data has been enrolled on the card 32, the fingerprint itself is not transmitted to the host control device 33 from the control unit 44.

Therefore, in this embodiment, the security of the fingerprint data can be ensured when the fingerprint is enrolled by providing security measures to the card-issuing device 31. Consequently, in this embodiment, while the security of the fingerprint data at the time of enrolling the fingerprint data can be ensured, the cost of the security measures can still be reduced.

In this embodiment, personal recognition data besides the fingerprint data is acquired by the card reader 37 or the scanner 38 and recorded on the card 32. Therefore, the fingerprint data and the personal recognition data can be associated together on the card 32. Also, the fingerprint data and the personal recognition data are acquired by a single card-issuing device 31 in this embodiment; therefore, the entire system including the card-issuing device 31 can be minimized.

### Other Embodiments

The above-described embodiment is an example of an embodiment of the present invention; however, it is not limited to this form, but can be varyingly modified within the scope of the present invention.

In the above-described embodiment, the card-issuing device 31 is equipped with the scanner 38 for reading personal recognition data recorded on an ID card, a passport or the like. Besides this configuration, the card-issuing device 31 may not be equipped with the scanner 38 if the card-issuing device 31 is not used for passports or the like but the card reader 37 reads the personal recognition data of the ID card. Also, the card-issuing device 31 may not be equipped with the scanner 38 if no personal recognition data is read in the card-issuing device 31.

In the above-described embodiment, the card-issuing device 31 is equipped with the printer 39; however, the card-issuing device 31 may not be equipped with the printer 39 if no printing is implemented on cards 32. The card-issuing device 31 may not be equipped with the card-transferring unit 40 when the card-issuing device 31 is equipped with neither he scanner 32 nor the printer 39 but the card supply unit 36 and the card reader 37 are arranged so that the card 32 sent out from the card supply unit 36 is directly transferred to the card reader 37.

In the above-described embodiment, the personal recognition data recorded on the ID card is read by the card reader 37; however, the card-issuing device 31 may be equipped with a card reader for reading the personal recognition data recorded on the ID card, other than the card reader 37. In this case, even when the card 32 is taken inside the card reader 37, the personal recognition data recorded on the ID card can be read. In the above-described embodiment, also, the card supply unit 36, the card reader 37, the scanner 38 and the printer 39 are arranged inside the case 41; however, at least one of those components can be arranged outside the case 41.

In the above-described embodiment, the external communication terminal 32a is formed in the card 32; however, a communication antenna may be embedded in the card 32 for contactless communication with the IC chip in the card 32. In this case, the card reader 37 records fingerprint data or/and personal recognition data on the IC chip in the card 32 with the communication antenna 53. Also, in the same case, the data-recording unit which records fingerprint data on the card 32 is a contactless IC card reader. With this configuration, the personal identification data which is recorded on the IC chip in the card 32 in advance is read by the communication antenna 53 at the time of issuing the card 32.

Also, a magnetic strip may be formed on the card 32, and fingerprint data and/or personal recognition data may be recorded on the magnetic strip of the card 32. In this case, the card reader 37 records fingerprint data and/or personal recognition data on the magnetic strip of the card 32 with the magnetic head 52. For this, a magnetic card reader is used as a data-recording unit for recording fingerprint data on the magnetic strip 32. When a magnetic strip is formed on a card 32, card individual identification data may be recorded on the magnetic strip in advance. In this case, the card individual identification data which is recorded on the magnetic strip in advance is read by the magnetic head 52 at the time of issuing the card 32.

Further, fingerprint data and/or personal recognition data may be recorded as barcode data which is printed on the surface of the card 32. In this case, the printer 39 records fingerprint data and/or personal recognition data as barcode data. For this, the printer 39 is used as the data-recording unit to record the fingerprint data on the card 32. In the above-described embodiment, the card individual identification data which is recorded on the IC chip of the card 32 in advance is read by the IC contact mechanism 51; however, the card individual identification data which is printed on the surface of the card 32 in advance may be read by the scanner 38.

In the above-described embodiment, the biometric authentication sensor for acquiring biometric authentication data is the fingerprint sensor 43 which acquires the fingerprint data of a user. Besides this, the biometric authentication sensor may be a vein recognition sensor which acquires the data of a user's palm or finger vein patterns. It may also be a facial recognition sensor which acquires the data of a user's facial shape. Also, the biometric authentication sensor may be an iris recognition sensor which acquires the data of an iris in the pupil of a user, a retinal recognition sensor which acquires the data of a retina of a user, or a voice recognition sensor which acquires the data of the voice of a user.

In the above-described embodiment, the card individual identification data is recorded in advance on the IC chip in the card 32 which is stored in the card-storing module of the card supply unit 36, and the card individual identification data is printed in advance on the surface of the card 32. Besides this, the card individual identification data may not be recorded in advance on the IC chip of the card 32 or may not be printed in advance on the surface of the card 32. When the card individual identification data is neither recorded in advance on the IC chip of the card 32 nor printed in advance on the surface of the card 32, the host control device 33 may specify the card individual identification data and also record the card individual identification data on the IC chip of the card 32 with the card reader 37 or print the card individual identification data on the surface of the card 32 with the printer 39 at the time of issuing the card 32.

In the above-described embodiment, the personal recognition data, which is different from the fingerprint data, is recorded on the card at the time of issuing the card 32; however, the personal recognition data which is different from the fingerprint data may not be recorded on the card 32. In the above-described embodiment, also, the card 32 is a vinyl chloride card having the thickness of 0.7 to 0.8 mm; however, the card 32 may be a PET (polyethylene terephthalate) card having the thickness of 0.18-0.36 mm or it may be a paper card having a prescribed thickness.

In addition to the above-described embodiment, the fingerprint sensor 43 may be provided with the function for encrypting the fingerprint data which is acquired by the fingerprint sensor 43, and also the card reader 37 may be provided with the function for decoding the encrypted fingerprint data. In this case, the security of the card-issuing device 31 can be increased. In the above-described embodiment, the card-issuing device 31 may be provided with a means to detect or prevent that the case 41 is illegally removed, part of the case 41 is damaged, or a control board (no illustration) of the card-issuing device 31 is illegally removed from the frame of the card-issuing device 31. Even in this case, the security of the card-issuing device 31 can be increased.

While the description above refers to particular embodiments of the present invention, it will be understood that many modifications may be made without departing from the spirit thereof. The accompanying claims are intended to cover such modifications as would fall within the true scope and spirit of the present invention.
The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A card reader for use with a card having biometric authentication information stored thereon, the card reader comprising:
a card-inserting opening at which the card is inserted;
a biometric authentication sensor arranged proximate to the card-inserting opening and structured to obtain user biometric authentication information from a user;
a data-reading means for reading card biometric authentication data on a card, which is biometric authentication data recorded on the card;
a storage unit for storing the user biometric authentication data acquired by the biometric authentication sensor; and
a control unit comprising a data-matching module for comparing the user biometric authentication data acquired by the sensor, which is stored in the storage unit, against the card biometric authentication data recorded on the card.

2. The card reader as set forth in claim 1 wherein
The card reader is mounted in a host device; and
THE control unit is structured to notify a host device, in which the card reader is mounted, of a comparison result at the data-matching module.

3. The card reader as set forth in claim 1, further comprising:
a light-emitting mechanism for illuminating the area surrounding the biometric authentication sensor;
wherein the control unit is structured to turn on the light-emitting mechanism in the light-emitting mode according to the matching result at the data-matching module.

4. The card reader as set forth in claim 1, wherein
a light-emitting mechanism is structured to illuminate the area surrounding the biometric authentication sensor;
the control unit comprises a data-acceptability-judging module for judging whether the biometric authentication data acquired by the sensor acceptably matches the biometric authentication data recorded on the card, and turns on the light-emitting mechanism in the light-emitting mode the data-acceptability-judging module judging that the user biometric authentication data is an acceptable match to the card biometric authentication data.

5. The card reader as set forth in claim 1, further comprising:
a card passage through which the card inserted at said card-inserting opening passes; and
an open-close mechanism having an opening-closing member structured to move between a closed position, at which the card passage is closed to keep the card from entering the inside of the card reader, and the open position, at which the card passage is opened to allow the card to enter the inside of the card reader;
wherein said control unit controls said open-close mechanism to move said opening-closing member positioned in said closed position to said open position when said biometric authentication data acquired by said sensor is acceptable data to match against said biometric authentication data recorded on said card.

6. The card reader as set forth in claim 1, wherein
the biometric authentication sensor is a fingerprint sensor; and
the data-reading means is an IC contact mechanism structured to read the biometric authentication data on the card, which is recorded on the IC chip, by contacting an external connection terminal of and IC chip built in the card, or an antenna which reads the biometric authentic data on the card, recorded on the IC chip, by communicating with a contactless communication antenna of the IC chip built in the card.

7. A card-issuing device comprising:
a card supply unit structured to store un issued cards and send out the cards one by one;
a biometric authentication sensor structured to acquire biometric authentication data; and
a data-recording unit structured to record the biometric authentication data, acquired by the biometric authentication sensor, on a card which is sent out from the card supply unit.

8. The card-issuing device as set forth in claim 7, wherein
at least either a card reader or scanner is provided to acquire personal recognition data different from the biometric authentication data.

9. The card-issuing device as set forth in claim 8, wherein
a printer structured to print on the card.

10. The card-issuing device as set forth in claim 7, wherein
the data-recording unit is a contact-type IC card reader having an IC contact mechanism which records the biometric data in said IC chip by contacting an external connection terminal of the IC chip built in the card, or a contactless IC card reader having a communication antenna which records the biometric authentication data in the chip by communicating with a contactless communication antenna of the IC chip built in the card.

11. A card reader for use with a card having card biometric authentication data recorded thereon, the card reader comprising:
a card-inserting opening at which the card is inserted;
a biometric authentication sensor arranged proximate to the card-inserting opening and structured to acquire user biometric authentication data from a user;
a contact structured to read the card biometric authentication data recorded on the card;
a memory structured to store the user biometric authentication data acquired by the biometric authentication sensor; and
a processor configured to compare the user biometric authentication data acquired by the sensor, which is stored in the storage unit, against the card biometric authentication data recorded on the card.
